(19) United States
(12) Patent Application Publication
(10) Pub. No.: US 2023/0204147 A1
(43) Pub. Date: Jun. 29, 2023

(54) HOSE ASSIST ATTACHMENT FOR VESSEL LEG

(71) Applicant: Tina Marie Funai, Saint Petersburg, FL (US)

(72) Inventor: Tina Marie Funai, Saint Petersburg, FL (US)

(21) Appl. No.: 18/146,115

(22) Filed: Dec. 23, 2022

Related U.S. Application Data
(60) Provisional application No. 63/293,144, filed on Dec. 23, 2021.

(51) Int. Cl. F16L 57/00; B65D 90/14

(52) U.S. Cl. CPC F16L 57/00; B65D 90/14

(57) ABSTRACT

A hose assist attachment for a vessel leg includes a cylindrical guard that encircles the vessel leg leveler. The guard has two symmetrical half collar components fastened together. The attachment improves a liquid vessel having a leg leveler, filling the gap that hoses otherwise get caught in, making transfers more efficient.

### CROSS-REFERENCE TO RELATED APPLICATION

This application claims the benefit of priority of U.S. provisional application number 63/293,144, filed Dec. 23, 2021, the contents of which are herein incorporated by reference.

### BACKGROUND OF THE INVENTION

The present invention relates to vessel leg levelers and, more particularly, to a hose assist attachment for a vessel leg.

Breweries tend to have slanted floors, so the brewing vessels have levelers to keep them straight. Transfer hoses get caught during transfers between the levelers and the floor, adding hours to each workday.

As can be seen, there is a need for a device to keep hoses from getting caught under levelers on vessels.

### SUMMARY OF THE INVENTION

In one aspect of the present invention, a hose assist attachment for a vessel leg comprises a cylindrical guard configured to encircle a vessel leg leveler, having two symmetrical half collar components; and a fastening means that fastens the two symmetrical half collar components together.

In another aspect of the present invention, the hose assist attachment is an improvement to a liquid vessel having a leg leveler.

The inventive attachment fills the gap that hoses get caught in and spins with the hoses, making transfers more efficient. Elimination of the need to unstick hoses streamlines the workday. It can be used in any field that uses leg levelers on their vessels, such as but not limited to breweries.

These and other features, aspects and advantages of the present invention will become better understood with reference to the following drawings, description, and claims.

### BRIEF DESCRIPTION OF THE DRAWINGS

FIG. 1 is a perspective view of a hose assist attachment according to an embodiment of the present invention, shown in use;

FIG. 2 is a detail perspective view thereof;

FIG. 3 is a top front perspective view thereof;

FIG. 4 is a bottom rear perspective view thereof;

FIG. 5 is a sectional view thereof, taken along line 5-5 in FIG. 2;

FIG. 6 is a sectional view thereof, taken along line 6-6 in FIG. 5;

FIG. 7 is an exploded view thereof, illustrating installation; and

FIG. 8 is a perspective view thereof, illustrating the function of the attachment.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a hose assist attachment or cylindrical guard configured to encircle a vessel leg leveler, comprising two half collar or half circle components.

The two half circles bolt together around the vessel leg, filling gaps between the vessel and the floor in which hoses get stuck and preventing entry of a hose in the gap. During transfers, hoses dragged against the device as they pass spin the device, simplifying the vessel transfer process. As such, the inventive attachment is an improvement on existing liquid vessels.

The two half cylinder components form an aperture therebetween dimensioned to accommodate a leveler or leveling post. The sidewalls of the half cylinder components are dimensioned such that the external circumference of the attachment is about equal to the circumference of the vessel leg. The height of the cylindrical guard is less than or equal to the height of the leveler between the foot and the leg of the vessel, such as between ¾ the height of the leveler and the full height of the leveler, leaving a sufficient gap to enable the guard to rotate freely.

The present disclosure further envisions adding wheels or ball bearings inside the device.

The method of manufacture is not particularly limited. The inventive guide may be printed on a three-dimensional (3D) printer, injection molded, carved from a block of material, etc. The material may be but is not limited to, for example, any suitable polymer.

To use the guard, a user may place the two half circles together around the legs between the levelers and the ground. The half circles may be fastened together, for example with bolts.

The fastening means is not particularly limited, as it may include for example bolts secured with nuts and with washers in some cases; a hinge and clasp; etc.

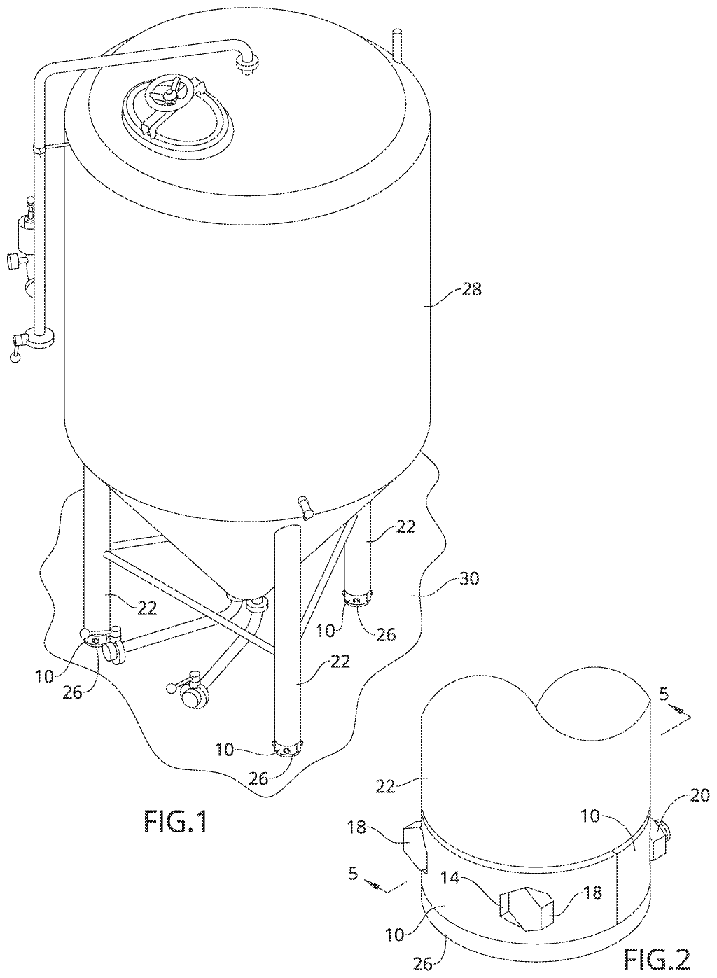

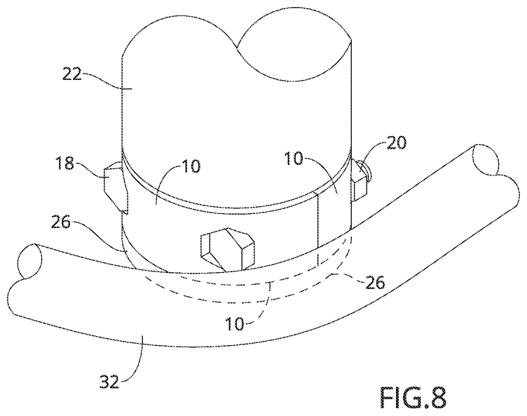

Referring to FIGS. 1 through 8, FIG. 1 illustrates a brewing vessel 28 having guards according to an embodiment of the present invention installed within the gap between the base of the legs 22 and the feet 26 on the ground 30. FIG. 2 illustrates a guard and foot 26 from FIG. 1 in more detail.

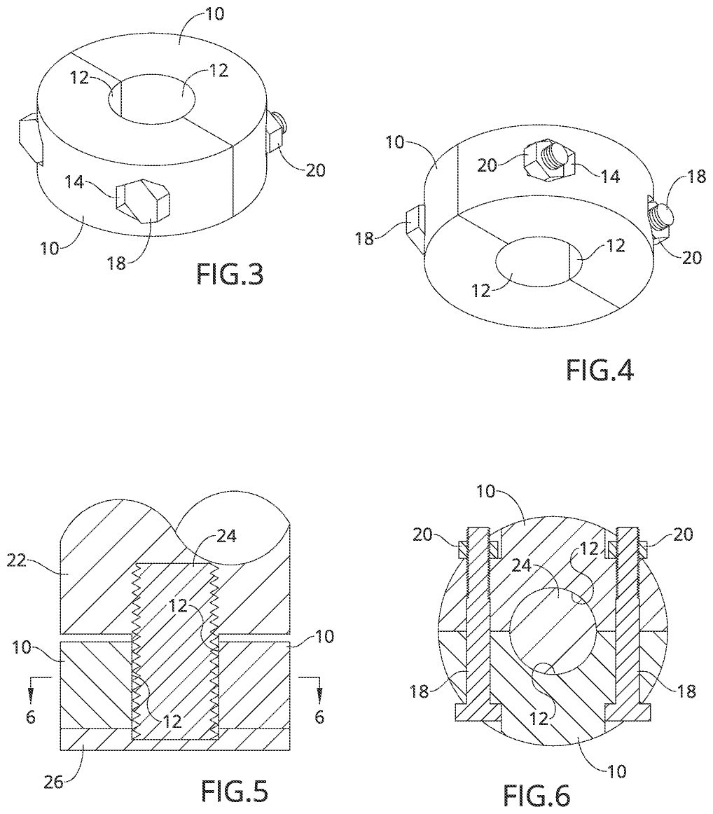

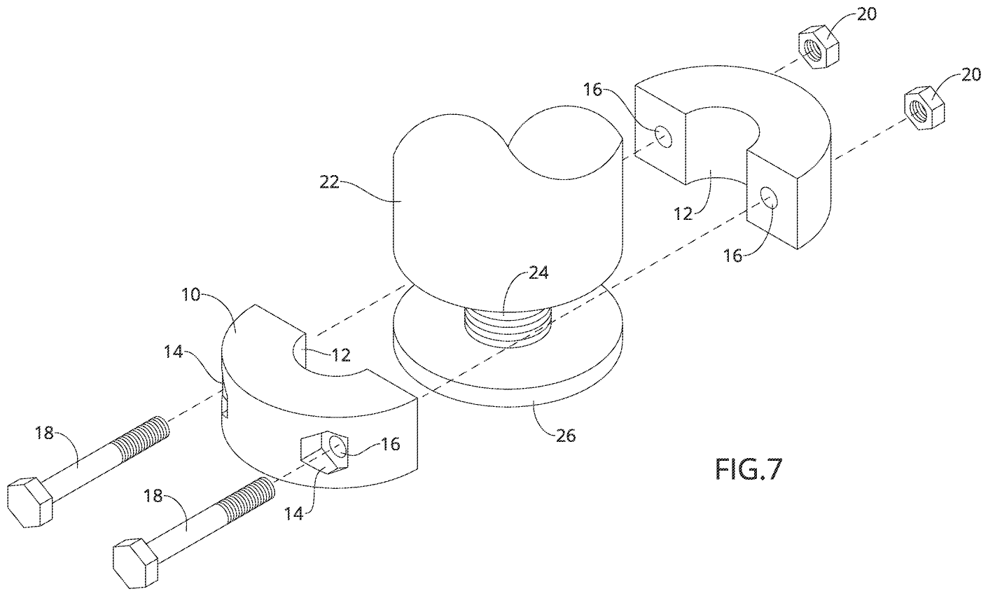

As shown more clearly in FIGS. 3 and 4, the guard comprises two collar halves 10 joined to form a cylinder encircling a center opening or aperture 12. Each of the halves 10 has parallel through holes 16 (see FIG. 7) that are aligned to accommodate bolts 18, the through holes 16 opening to hexagonal slots or indentations 14 at each end in the outer circumference. The guard may be assembled by fastening the collar halves 10 together with bolts 18 inserted into the through holes 16. The bolt 18 heads are held snugly in place within the hexagonal slots 14 while nuts 20 are threadedly installed on the bolt 18 at its other end. In other words, the hexagonal indentations 14 snugly accommodate the bolt 18 heads.

FIGS. 5 through 7 illustrate the collar halves 10 installed around a leveling post 24 of the vessel 28, such that no gap remains within which a hose 32 may be trapped. During transfer, the hose 32 slides against the circumference of the guard, rotating the guard in place around the leveling post 24, making the transfer process much easier and quicker.

It should be understood, of course, that the foregoing relates to exemplary embodiments of the invention and that modifications may be made without departing from the spirit and scope of the invention as set forth in the following claims.

What is claimed is:

1. A hose assist attachment for a vessel leg, comprising:
a cylindrical guard configured to encircle a vessel leg leveler, having two symmetrical half collar components; and
a fastening means that fastens the two symmetrical half collar components together.

2. The hose assist attachment of claim 1, wherein the cylindrical guard is dimensioned to prevent entry of a transfer hose between the vessel leg and a vessel foot and/or a floor.

3. The hose assist attachment of claim 1, wherein the cylindrical guard is configured to rotate around the vessel leg leveler.

4. The hose assist attachment of claim 1, wherein the fastening means is a pair of bolts.

5. The hose assist attachment of claim 1, wherein the bolts is threadedly secured with nuts.

6. The hose assist attachment of claim 4, wherein the symmetrical half collar components each define two parallel through holes, aligned to accommodate the bolts.

7. The hose assist attachment of claim 5, wherein the symmetrical half collar components define a hexagonal indentation around at least one end of each of the parallel through holes, the hexagonal indentation operative to snugly accommodate a bolt head.

8. An improvement to a liquid vessel having a leg leveler, comprising the hose assist attachment of claim 1.
